(19) United States
(12) Patent Application Publication
(10) Pub. No.: US 2026/0019977 A1
(43) Pub. Date: Jan. 15, 2026

(54) METHODS AND SYSTEMS FOR HANDLING SATELLITE PARAMETERS IN A NEXT GENERATAION COMMUNICATION SYSTEM

(71) Applicant: Samsung Electronics Co., Ltd., Suwon-si (KR)

(72) Inventors: Lalith KUMAR, Bengaluru (IN); Utsav SINHA, Bengaluru (IN); Aman AGARWAL, Bengaluru (IN); Sidhant JAIN, Bengaluru (IN); Dinesh Rooparam CHOUDHARY, Bengaluru (IN); Vishal YADAV, Bengaluru (IN)

(21) Appl. No.: 19/265,622

(22) Filed: Jul. 10, 2025

(30) Foreign Application Priority Data
Jul. 15, 2024 (IN) 202441054003
Jul. 22, 2024 (IN) 202441055833
Jun. 27, 2025 (IN) 2024 41054003

(51) Int. Cl. H04W 60/06; H04W 84/06

(52) U.S. Cl. CPC H04W 60/06; H04W 84/06

(57) ABSTRACT

Methods and systems performed by a terminal in a communication system are provided. The methods and systems include, receiving, from a mobility management entity (MME) of a non-terrestrial network (NTN) node, a detach request message for initiating a detach procedure, in an evolved-universal mobile telecommunication access (E-UTRA) mobility management (EMM)-REGISTERED state, and entering an EMM-DEREGISTERED state after the detach procedure, wherein the detach request message includes information on a store and forward (S&F) satellite operation, the information on the S&F satellite operation including an S&F monitoring list of a satellite identity (ID).

### CROSS-REFERENCE TO RELATED APPLICATION(S)

This application is based on and claims priority under 35 U.S.C. § 119 (a) of an Indian Provisional patent application No. 202441054003, filed on Jul. 15, 2024, in the Indian Patent Office, of an Indian Provisional patent application No. 202441055833, filed on Jul. 22, 2024, in the Indian Patent Office, and of an Indian Complete patent application No. 202441054003, filed on Jun. 27, 2025, in the Indian Patent Office, the disclosure of each of which is incorporated by reference herein in its entirety.

### BACKGROUND

### 1. Field

The disclosure relates to third generation partnership project (3GPP) networks. More particularly, the disclosure relates to managing satellite parameters in 3GPP networks.

### 2. Description of Related Art

Fifth generation (5G) mobile communication technologies define broad frequency bands such that high transmission rates and new services are possible, and can be implemented not only in “Sub 6 gigahertz (GHZ)” bands such as 3.5 GHZ, but also in “Above 6 GHz” bands referred to as mmWave including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The radio access over a non-terrestrial network (NTN) provides an enhanced coverage. In an NTN, signaling and data are exchanged via a feeder link and a service link based on an operation mode. For example, the satellite can receive signaling/data from the terminal via a service link without an active feeder link in the Store and Forward (S&F) Satellite operation mode. The S&F satellite operation mode is suitable for delay-tolerant communication services.

When the terminal supporting the S&F Satellite operation mode is detached from the network, there are no solutions to handle paging for the terminal or to manage power consumption of the terminal.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for managing satellite parameters in 3GPP networks.

Another aspect of the disclosure is to provide methods and systems for managing satellite parameters in 3GPP networks, on a UE receiving a paging message.

Another aspect of the disclosure is to provide methods and systems for managing satellite parameters in 3GPP networks, on a UE receiving a DETACH REQUEST message (MSG) from the network.

Another aspect of the disclosure herein is to provide methods and systems for handling validity of satellite identity (ID) and tracking area identity (TAI) list in 3GPP networks.

Additional aspects will be set forth in part in the description which follows and, in part, will be apparent from the description, or may be learned by practice of the presented embodiments.

In accordance with an aspect of the disclosure, a method performed by a terminal in a communication system is provided. The method includes receiving, from a mobility management entity (MME) of a non-terrestrial network (NTN) node, a detach request message for initiating a detach procedure, in an evolved-universal mobile telecommunication access (E-UTRA) mobility management (EMM)-REGISTERED state, and entering an EMM-DEREGISTERED state after the detach procedure, wherein the detach request message includes information on a store and forward (S&F) satellite operation, the information on the S&F satellite operation including an S&F monitoring list of a satellite identity (ID).

In accordance with another aspect of the disclosure, a method performed by a non-terrestrial network (NTN) node in a communication system is provided. The method includes determining to initiate a detach procedure for a terminal in an evolved-universal mobile telecommunication access (E-UTRA) mobility management (EMM)-REGISTERED state, based on a current location of the terminal, and transmitting, by a mobility management entity (MME) of the NTN node to the terminal, a detach request message including information on a store and forward (S&F) satellite operation, the information on the S&F satellite operation including an S&F monitoring list of a satellite identity (ID), wherein the EMM-REGISTERED state is changed to an EMM-DEREGISTERED state after the detach procedure.

In accordance with another aspect of the disclosure, a terminal in a communication system is provided. The terminal includes a transceiver, memory, comprising one or more storage media, storing instructions, and one or more processors communicatively coupled to the transceiver and the memory, wherein the instructions, when executed by the one or more processors individually or collectively, cause the terminal to control the transceiver to receive, from a mobility management entity (MME) of a non-terrestrial network (NTN) node, a detach request message for initiating a detach procedure, in an evolved-universal mobile telecommunication access (E-UTRA) mobility management (EMM)-REGISTERED state, and enter an EMM-DEREGISTERED state after the detach procedure, wherein the detach request message includes information on a store and forward (S&F) satellite operation, the information on the S&F satellite operation including an S&F monitoring list of a satellite identity (ID).

In accordance with another aspect of the disclosure, a non-terrestrial network (NTN) node in a communication system is provided. The NTN node includes a base station, a mobility management entity (MME) which comprises a transceiver and a controller, memory, comprising one or more storage media, storing instructions, and, and one or more processors communicatively coupled to the base station, the MME, the transceiver, and the memory, wherein the instructions, when executed by the one or more processors individually or collectively, cause the NTN node to determine to initiate a detach procedure for a terminal in an evolved-universal mobile telecommunication access (E-UTRA) mobility management (EMM)-REGISTERED state, based on a current location of the terminal, and control the transceiver to transmit, to the terminal, a detach request message including information on a store and forward (S&F) satellite operation, the information on the S&F satellite operation including an S&F monitoring list of a satellite identity (ID), and wherein the EMM-REGISTERED state is changed to an EMM-DEREGISTERED state after the detach procedure.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, from a mobility management entity (MME) of a non-terrestrial network (NTN) node, a detach request message for initiating a detach procedure, in an evolved-universal mobile telecommunication access (E-UTRA) mobility management (EMM)-REGISTERED state, and entering an EMM-DEREGISTERED state after the detach procedure, wherein the detach request message includes information on a store and forward (S&F) satellite operation, the information on the S&F satellite operation including an S&F monitoring list of a satellite identity (ID).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates the S&F operation, according to an embodiment of the disclosure;

FIG. 1B illustrates the S&F operation, according to an embodiment of the disclosure;

FIG. 2 illustrates an example scenario, wherein the UE receives a paging indication from the network when the wait timer is running, according to an embodiment of the disclosure;

FIG. 3 illustrates a scenario, wherein the UE gets detached due to a network initiated DETACH REQ, according to an embodiment of the disclosure;

FIG. 4 is a schematic diagram illustrating UE behavior when the satellite radio access network (RAN) is not broadcasting any Satellite ID in the broadcast (for example, master information block (MIB)/system information block (SIB)) or any access stratum (AS) or non-access stratum (NAS) message, according to an embodiment of the disclosure;

FIG. 5 is a schematic diagram illustrating UE behavior when the location of the UE has changed from the time when it received the Satellite ID(s) from the network, according to an embodiment of the disclosure;

FIG. 6 illustrates a 3GPP network, according to an embodiment of the disclosure;

FIG. 7 illustrates a scenario, wherein a UE receives a paging indication from the network, according to an embodiment of the disclosure;

FIG. 8 illustrates a scenario, wherein the UE gets detached due to a network initiated DETACH REQUEST message which can be triggered to detach the UE from the packet-switched (PS) or PS/circuit-switched (CS) or CS services, or network initiated deregistration request message, according to an embodiment of the disclosure;

FIG. 9 is a schematic diagram illustrating UE behavior when the satellite RAN is not broadcasting any Satellite ID in the broadcast (for example, MIB/SIB) or any AS or NAS message, and the UE is having satellite ID(s) (also referred to herein as a list of satellite IDs), according to an embodiment of the disclosure;

FIG. 10 is a schematic diagram illustrating UE behavior when the satellite RAN is not broadcasting any Satellite ID in the broadcast (for example, MIB/SIB) or any AS or NAS message, and the UE does not have satellite ID(s), according to an embodiment of the disclosure;

FIG. 11 is a sequence diagram illustrating UE behavior when UE location has changed from the time when it received the Satellite ID(s) from the network, according to an embodiment of the disclosure;

FIG. 12 is a diagram illustrating the behavior of the UE, when the location of the UE has changed from the time when it received the Satellite ID(s) from the network, according to an embodiment of the disclosure;

FIG. 13 illustrates a UE, according to an embodiment of the disclosure;

FIG. 14 is a flowchart depicting the process of handling S&F satellite operations in the 3GPP network, according to an embodiment of the disclosure;

FIG. 15 illustrates an MME on-board, according to an embodiment of the disclosure; and

FIG. 16 is a flowchart depicting a process of handling S&F satellite operations in the 3GPP network, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “example,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (for example, one or more programmed microprocessors and associated circuitry), or by a combination of dedicated hardware to perform some functions of the block and a processor to perform other functions of the block. Each block of the embodiments, for example, may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

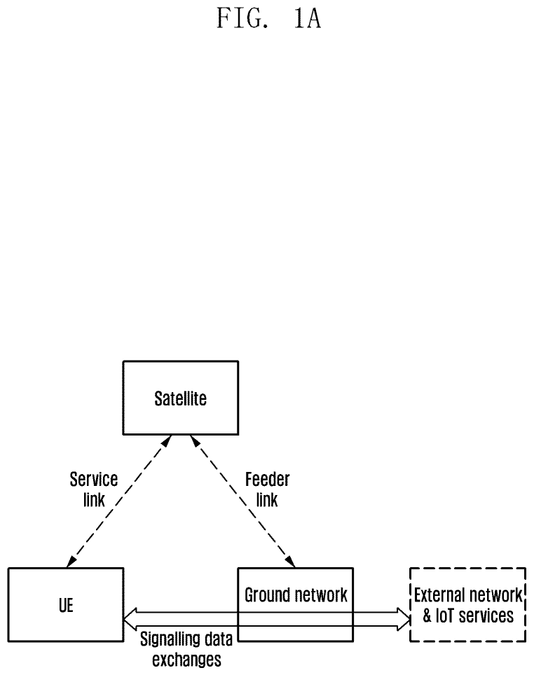

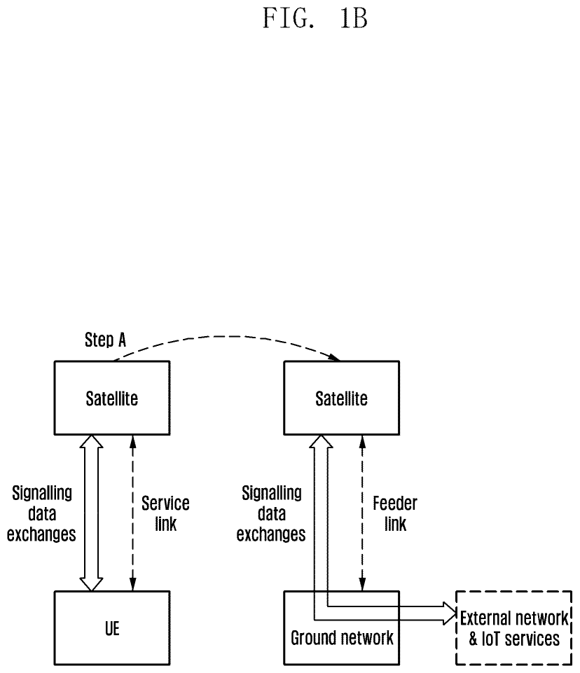

The embodiments herein achieve methods and systems for managing satellite parameters in 3GPP networks. Referring now to the drawings, and more particularly to FIGS. 1A, 1B, and 2 to 16, where similar reference characters denote corresponding features consistently throughout the figures, there are shown embodiments.

The following definitions and abbreviations have been referred to herein:
3GPP: Third Generation Partnership Project
4G-GUTI: 4G-Globally Unique Temporary Identifier
5G-BRG: 5G Broadband Residential Gateway
5GC: 5G Core
5GCN: 5G Core Network
5G-CRG: 5G Cable Residential Gateway
5G-GUTI: 5G-Globally Unique Temporary Identifier
5GMM: 5G Mobility Management
5G-RG: 5G Residential Gateway
5GS: 5G System
5GSM: 5GS Session Management
5G-S-TMSI: 5G S-Temporary Mobile Subscription Identifier
5G-TMSI: 5G Temporary Mobile Subscription Identifier
5QI: 5G QOS Identifier
ACS: Auto-Configuration Server
AKA: Authentication and Key Agreement
A-KID: AKMA Key Identifier
AKMA: Authentication and Key Management for Applications
AMBR: Aggregate Maximum Bit Rate
AMF: Access and Mobility Management Function
APN: Access Point Name
ARP: Allocation and Retention Policy
AS: Access Stratum
A-TID: AKMA Temporary Identifier
ATSSS: Access Traffic Steering, Switching and Splitting
AUSF: Authentication Server Function
CAG: Closed access group
CAG ID: Closed Access Group Identifier
CHAP: Challenge Handshake Authentication Protocol
CU: Centralized Unit
DC: Discontinuous Coverage
DisCo: Discontinuous Coverage
DL: Downlink
DND: Do not Disturb
DRX: Discontinuous Reception
DU: Distributed Unit
eDRX: Extended Discontinuous Reception
EHPLMN: Equivalent Home Public Land Mobile Network
EMM: EUTRA Mobility Management
eNB: Evolved Node-B
eNPN: Enhanced Non-Public Networks
EPC: Evolved Packet Core
EPLMN: Equivalent Public Land Mobile Network
EPS: Evolved Packet System
eSIM: embedded Subscriber Identity Module
E-UTRA: Evolved Universal Mobile Telecommunication Access
EUTRAN: Evolved Universal Mobile Telecommunication Access Network
FPLMN: Forbidden Public Land Mobile Network
FR: Frequency Range
GEO: Geostationary Orbit
GERAN: GSM Edge Radio Access Network
GERAN EC-GSM-IoT: GSM Edge Radio Access Network Extended Coverage-GSM-Internet of Things
gNB: Next generation Node-B
gNB-CU: Next generation Node-B Control Unit
gNB-DU: Next generation Node-B Distributive Unit
GPRS: General Packet Radio Service
GPS: Global Positioning System
GSM: Global System for Mobile Communication
HPLMN: Home Public Land Mobile Network
IAB: Integrated access and backhaul
IAB-UE: The part of the IAB node that supports the Uu interface towards the IAB-donor or another parent IAB-node (and thus manages the backhaul connectivity with either public land mobile network (PLMN) or standalone non-public networks (SNPN) it is registered with) is referred to as an IAB-UE.
LADN: Local Area Data Network
LCS: Location services
LEO: Low Earth Orbit
MBSR: Mobile Base Station Relay
MCC: Mobile Country Code
MCS: Mission Critical Service
ME: Mobile Equipment
MEC: Multi-Access Edge Computing
MEO: Medium Earth Orbit
MICO: Mobile Initiated Communication Only
MINT: Minimization of service interruption
MME: Mobility Management Entity
MNC: Mobile Network Code
MPS: Multimedia Priority Service
MS: Mobile Station. The document makes no distinction between the MS and the UE.
NAS: Non-Access Stratum
NB-S1 Mode: Narrow Band with S1 Interface
NGAP: Next Generation Application Protocol
NG-RAN: Next Generation Radio Access Network
NPN: Non-Public Networks
NR: New Radio
NTN: Non Terrestrial Networks
NW: Network
OOS Out of Service
OS Upgrade: Operating System Upgrade
PDN: Packet Data Network
PDU: Packet Data Unit
PLMN ID: Public Land Mobile Network Identity
PSM: Power Saving Mode
QoS: Quality Of Service
RAT: Radio Access Technology
RPLMN: Registered Public Land Mobile Network
RRC: Radio Resource Control
RU: Registration Update
SAT: Satellite
Satellite: An artificial body placed in orbit round the earth or moon or another planet in order to collect information or for communication.
Satellite Constellation: A group of satellites, placed in orbit round the earth or moon or another planet in order to collect information or for communication.
Service User: An individual who has received a priority level assignment from a regional/national authority (i.e., an agency authorized to issue priority assignments) and has a subscription to a mobile network operator
SIM: Subscriber Identity Module
SNPN: Standalone Non-Public Networks
SUCI: Subscription Concealed Identifier
SW: Software
TAC: Tracking Area Code
TAI: Tracking Area Identity
TAU: Tracking Area Update
TER: Terrestrial
TN: Terrestrial Networks
UCU: UE Configuration Update
UDM: Unified Data Management Function
UE: User Equipment
UL: Uplink
ULI: User Location Information
UPU: UE Parameters Update
USIM: Universal Subscriber Identification Module
Uu: The radio interface between the UE and the Node B
VMR: Vehicle Mounted Relay
VPLMN: Visited Public Land Mobile Network
WB-S1 Mode: Wide Band with S1 Interface

Visited PLMN (VPLMN): This is a PLMN different from the HPLMN (if the EHPLMN list is not present or is empty) or different from an EHPLMN (if the EHPLMN list is present).

Allowable PLMN: In the case of an MS operating in MS operation mode A or B, this is a PLMN which is not in the list of “forbidden PLMNs” in the MS. In an embodiment, in the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: PLMN(s) in the given area which is/are broadcasting capability to provide wireless communication services to the UE.

Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.

EHPLMN: Any of the PLMN entries contained in the Equivalent HPLMN list.

Equivalent HPLMN list: To allow provision for multiple HPLMN codes, PLMN codes that are present within this list shall replace the HPLMN code derived from the IMSI for PLMN selection purposes. This list, for example, is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.

Home PLMN: This is a PLMN where the MCC and MNC of the PLMN identity match the MCC and MNC of the IMSI.

Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.

Registration: This is the process of camping on a cell of the PLMN or the SNPN and doing any necessary LRs.

UPLMN: PLMN/access technology combination in the “User Controlled PLMN Selector with Access Technology” data file in the SIM (in priority order);

OPLMN: PLMN/access technology combination in the “Operator Controlled PLMN Selector with Access Technology” data file in the SIM (in priority order) or stored in the ME (in priority order).

Serving satellite: A satellite providing the satellite access to a UE. In the case of NGSO (Non-Geostationary Satellite Orbit), the serving satellite is always changing due to the nature of the constellation.

Store & Forward Satellite operation: In the context of this study, it is an operation mode of a 5G system with satellite-access where the 5G system can provide some level of service (in storing and forwarding the data) when satellite connectivity is intermittently/temporarily unavailable; for example, to provide communication service for UEs under satellite coverage without a simultaneous active feeder link connection to the ground segment.

S&F data retention period: This is the data storage validity period for the 5G system with satellite access supporting store and forward operation (for example, after which stored undelivered data is being discarded).

UE-Satellite-UE Communication: For the 5G system with satellite access, it refers to the communication between UEs under the coverage of one or more serving satellites, using satellite access without going through the ground segment.

Paging: Paging is used to search for Idle UEs and establish a signaling connection. Paging is, for example, triggered by downlink packets arriving to the UPF. When the UPF receives a downlink packet destined for an Idle UE, it does not have an NG-RAN User Plane tunnel address to which it can send the packet. In an embodiment, the UPF instead buffers the packet and informs the SMF that a downlink packet has arrived. The SMF asks the AMF to setup User Plane resources for the PDU Session, and the AMF which knows in which RA the UE is located and sends a paging request to the NG-RAN within the RA. The NG-RAN calculates at which occasion the UE is to be paged using parts of the UE's 5G-S-TMSI (10 bits) as input, and then the NG-RAN pages the UE. Upon receipt of the paging message, the UE responds to the AMF and the User Plane resources are activated so that the downlink packet may be forwarded to the UE.

Examples of the NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command; UE PARAMETERS UPDATE command; and so on.

In an embodiment, the term 5GMM sublayer states in this embodiment are at least one of the below:
1) 5GMM-NULL
2) 5GMM-DEREGISTERED
   a) 5GMM-DEREGISTERED.NORMAL-SERVICE
   b) 5GMM-DEREGISTERED.LIMITED-SERVICE
   c) 5GMM-DEREGISTERED.ATTEMPTING-REGISTRATION
   d) 5GMM-DEREGISTERED.PLMN-SEARCH
   e) 5GMM-DEREGISTERED.NO-SUPI
   f) 5GMM-DEREGISTERED.NO-CELL-AVAILABLE
   g) 5GMM-DEREGISTERED.eCALL-INACTIVE
   h) 5GMM-DEREGISTERED.INITIAL-REGISTRATION-NEEDED
3) 5GMM-REGISTERED-INITIATED
4) 5GMM-REGISTERED
   a) 5GMM-REGISTERED.NORMAL-SERVICE
   b) 5GMM-REGISTERED.NON-ALLOWED-SERVICE
   c) 5GMM-REGISTERED.ATTEMPTING-REGISTRATION-UPDATE
   d) 5GMM-REGISTERED.LIMITED-SERVICE
   e) 5GMM-REGISTERED.PLMN-SEARCH
   f) 5GMM-REGISTERED.NO-CELL-AVAILABLE
   g) 5GMM-REGISTERED.UPDATE-NEEDED
5) 5GMM-DEREGISTERED-INITIATED
6) 5GMM-SERVICE-REQUEST-INITIATED

In this embodiment, the term EMM sublayer states are at least one of the below:
1) EMM-NULL
2) EMM-DEREGISTERED
   a) EMM-DEREGISTERED.NORMAL-SERVICE
   b) EMM-DEREGISTERED.LIMITED-SERVICE
   c) EMM-DEREGISTERED.ATTEMPTING-TO-ATTACH
   d) EMM-DEREGISTERED.PLMN-SEARCH
   e) EMM-DEREGISTERED.NO-IMSI
   f) EMM-DEREGISTERED.ATTACH-NEEDED
   g) EMM-DEREGISTERED.NO-CELL-AVAILABLE
   h) EMM-DEREGISTERED.eCALL-INACTIVE
3) EMM-REGISTERED-INITIATED
4) EMM-REGISTERED
   a) EMM-REGISTERED.NORMAL-SERVICE
   b) EMM-REGISTERED.ATTEMPTING-TO-UPDATE
   c) EMM-REGISTERED.LIMITED-SERVICE
   d) EMM-REGISTERED.PLMN-SEARCH
   e) EMM-REGISTERED.UPDATE-NEEDED
   f) EMM-REGISTERED.NO-CELL-AVAILABLE
   g) EMM-REGISTERED.ATTEMPTING-TO-UPDATE-MM
   h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as defined in this embodiment can be one of the following: NG-RAN, 5G, 4G, 3G, 2G, EPS, 5GS, NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands, NB-IoT, WB-IoT, long term evolution for machines (LTE-M), and so on

5GS registration type can be one of initial registration, mobility registration updating, periodic registration updating, emergency registration, SNPN onboarding registration, disaster roaming initial registration; disaster roaming mobility registration updating, and so on.

Not set the registration type to disaster roaming initial registration or disaster roaming mobility registration updating means 5GS registration type is set to value other than “disaster roaming initial registration” or ““disaster roaming mobility registration updating” at least one of initial registration, mobility registration updating, periodic registration updating, emergency registration, SNPN onboarding registration, and so on.

PLMN selection as per 23.122 without RPLMN:

The MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

PLMN selection as per 23.122 with RPLMN:

In an embodiment, the MS selects and attempts registration on any PLMN/access technology combinations, if available and allowable, in the following order:
either the RPLMN or the Last registered PLMN;
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

For a 5G system with satellite access, the following requirements apply:
The 5G system shall support service continuity between NR terrestrial access network and NR satellite access networks owned by the same operator or owned by 2 different operators having an agreement.

In an embodiment, the NTN and TN could either operate in two different frequency bands (for example, FR1 vs FR2), or in same frequency band (for example, FR1 or FR2).

The Satellite System or Satellite Access as used or defined in this embodiment is applicable for both 5G systems with satellite access and/or fourth generation (4G) systems with satellite access or any RAT with satellite access.

The terms Satellite 3GPP access, Satellite access, Satellite Access Network, NR Satellite Access Network, Satellite NG-RAN Access Technology and NR Satellite access have been interchangeably used and have the same meaning.

The methods, issues or solutions disclosed in this embodiment are explained using NR satellite access or Satellite NG-RAN Access Technology as an example and are not restricted or limited to NR Satellite access only. However, the solutions proposed in this embodiment are also applicable for Satellite evolved-universal terrestrial radio access network (E-UTRAN) access Technology, Narrow Band (NB)-S1 mode or Wide Band (WB)-S1 mode via satellite E-UTRAN access and/or Narrow Band Internet Of Things (NB-IoT) or WideBand Internet Of Things (WB-IoT) Satellite Access/Architecture.

The solutions which are defined for NR (5GC) are also applicable to legacy RATs like E-UTRA/LTE, the corresponding CN entities need to be replaced by LTE entities; for example, AMF with MME, g-nodeB with e-nodeB, UDM with HSS, and so on. But principles of the solution remain same. In the similar way, the solutions or proposal which are defined for LTE (EPC) are also applicable to other RAT(s) (for example, 5G or 5GC and other RATs).

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in this embodiment is explained using any 5G Core Network Function (for example, AMF). The network could be any 5G/EUTRAN Core Network entity (such as, but not limited to, AMF, SMF, MME, UPF, and so on) or the Network could be any 5G/EUTRAN RAN Entity (such as, but not limited to, eNodeB (eNB), gNodeB (gNB), NG-RAN, and so on).

The messages used or indicated in this embodiment are shown as an example. The messages could be any signalling message between the UE and the Network Functions/Entities or between different Network functions/entities.

The term area/location/geographical area as referred to herein may refer to any of cell/cell ID, TAC/TAI, PLMN, MCC/MNC, Latitude/longitude, CAG cell or any geographical location/coordinate.

The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB-S1 mode or WB-S1 mode via E-UTRAN access and/or NB-IoT or WB-IoT Access/Architecture.

The solutions which are defined for NR (5GC) are also applicable to legacy RATs (such as, but not limited to, E-UTRA/LTE), wherein the corresponding CN entities needs to be replaced by LTE entities; (for example, AMF with MME, g-nodeB with e-nodeB, UDM with HSS, and so on). But principles of the solution remains same.

The Network as referred to herein is explained using any 5G Core Network Function (for example, AMF). However, the network could be any 5G/EUTRAN Core Network entity (such as, but not limited to, AMF, SMF, MME, UPF, and so on) or the Network could be any 5G/EUTRAN RAN entity (such as, but not limited to, eNodeB (eNB), gNodeB (gNB), NG-RAN, and so on).

In an embodiment, the messages used or indicated in this embodiment are shown as an example. The messages could be any signalling messages between UE and the Network Functions/Entities or between different Network functions/entities.

The terms ‘camp’ and ‘register’ are used interchangeably and have the same meaning.

The terms ‘wait timer’, DisCo wait timer′, ‘Discontinuous Coverage wait timer’, ‘Random timer’, ‘Random wait timer’, and ‘DCW Timer’ are all used interchangeably and have the same meaning.

The terms ‘wait range’, ‘Disco Wait Range’, ‘Discontinuous Coverage Wait Range’, and ‘DCW Range’ are all used interchangeably and have the same meaning.

The term ‘area’ as used in this embodiment may refer to any of cell/cell ID, TAC/TAI, PLMN, MCC/MNC, Latitude/longitude, any CAG/CAG identifier or any geographical location/coordinate.

For the list of possible NAS messages, 3GPP TS 24.501 or 3GPP TS 24.301 can be referred. For the list of AS messages, 3GPP TS 38.331 or 3GPP TS 36.331 can be referred.

In an embodiment, the cause names in this embodiment are for illustration purposes and it can have any name. The non-access stratum (NAS) messages and access stratum (AS) messages described herein are only for illustration purposes, however it can be obvious to a person of ordinary skill in the art that it can be any NAS or AS messages as per defined protocol between the UE and the AMF/MME, or the UE and the gNB (NG-RAN/any RAN node)/eNB.

In this embodiment herein, the term ‘Satellite’ is used interchangeably with 5G or 4G system with satellite access and is used to represent any Satellite(s) or constellation of Satellites(s) or any aerial body/satellite in any of the Satellite orbits (for example, LEO, MEO, GEO, HEO, and so on) or any 5G system with Satellite Access or 4G System with Satellite Access or any RAN Entity or Core Network Entity or any Network Function(s) associated with the Satellite Access/RAT/PLMN/Network.

The solutions in these embodiments are illustrated using E-UTRA/LTE RAT/core network, but it is equally applicable for 5GS, wherein the corresponding CN entities need to be replaced by 5GS entities (for example, MME with AMF, E-nodeB with g-nodeB, HSS with UDM, and so on); but principles of the solution remain the same.

Embodiments herein disclose methods and systems for handling validity of satellite ID and TAI list. A UE starts an initial Attach procedure/tracking area update (TAU) procedure and sends an Attach request/TAU request to the MME on-board satellite (for example, SAT-1 (NG-RAN-1)) via an available service link. An MME on-board sends a DL NAS message (for example, a NAS message (for example, Attach Accept/Reject, Tracking Area update Accept/Reject or any other NAS message)) to the UE. The MME on-board may or may not include the satellite ID(s) in the DL NAS message. Consider that the UE has moved to a new location or if the time has changed or another satellite coverage (for example, SAT-3) becomes available, and the UE has Satellite ID(s) stored or not. When the satellite RAN (for example, SAT-3 (NG-RAN-3)) is not broadcasting any Satellite ID in the broadcast (for example, MIB/SIB) or any AS or NAS message, the UE should not attempt to camp or/and register on this satellite network which does not broadcast the Satellite ID in any AS/NAS message or any broadcast message (for example, MIB, SIB, and so on). In an embodiment herein, the UE can attempt to camp or/and register on this satellite network which does not broadcast the Satellite ID in any AS/NAS message or any broadcast message (for example, MIB, SIB).

In an embodiment, the granularity of the TAI list as disclosed herein can be a cell, any geographical location, a CAG or any area unit, as referred to herein.

In a Store and Forward (S&F) Satellite operation in a 5G system with satellite access is intended to provide some level of communication service for UEs under satellite coverage with intermittent/temporary satellite connectivity (for example, when the satellite is not connected via a feeder link or via ISL to the ground network) for delay-tolerant communication service. An example of “S&F Satellite operation” is illustrated in FIGS. 1A and 1B, in contrast to what could be considered the current assumption for the “normal/default Satellite operation” of a 5G system with satellite access.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1A illustrates the S&F operation, according to an embodiment of the disclosure.

FIG. 1B illustrates the S&F operation, according to an embodiment of the disclosure.

Referring to FIGS. 1A and 1B, under “normal/default Satellite operation” mode, signalling and data traffic exchange between a UE with satellite access and the remote ground network requires the service and feeder links to be active simultaneously, so that, at the time that the UE interacts over the service link with the satellite, there is a continuous end-to-end connectivity path between the UE, the satellite and the ground network.

In contrast, under “S&F Satellite operation” mode, the end-to-end exchange of signalling/data traffic is now handled as a combination of two steps not concurrent in time (steps A and B in FIG. 1B). In step A, signalling/data exchange between the UE and the satellite takes place, without the satellite being simultaneously connected to the ground network (i.e. the satellite can operate the service link without an active feeder link connection). In step B, connectivity between the satellite and the ground network is established so that communication between the satellite and the ground network can take place. The satellite moves from being connected to the UE in step A to being connected to the ground network in step B.

The concept of “S&F” service is widely used in the fields of delay-tolerant networking and disruption-tolerant networking. In 3GPP context, a service that could be assimilated to an S&F service is short message service (SMS), for which there is no need to have an end-to-end connectivity between the endpoints (example an endpoint can be a UE and the other an application server) but only between the end-points and the short message service center (SMSC) which acts as an intermediate node in charge of storing and relying.

The support of S&F Satellite operation is especially suited for the delivery of delay-tolerant/non-real-time IoT satellite services with non-geostationary satellite orbit (NGSO) satellites.

MME functionality is split into two parts: MME-onboard—the MME part which is onboard the satellite and MME-ground. When the UE initiates Attach or TAU procedure, it indicates support for S&F mode to the MME following existing NAS capability, the MME sends Attach or TAU Reject message to the UE if these procedures cannot be completed due to S&F operation. The Attach or TAU Reject message includes:

a) A new information indicating the UE that attach or TAU procedure cannot be completed because of the S&F operation and that the UE can re-attempt the attach or TAU in this PLMN in a next satellite pass. This indicates to the UE that the information contained in the Attach or TAU Request message is stored by the MME and the network will be available to the UE after interaction with ground network.

b) Wait timer: Indicates to the UE the time it should wait before re-attempting the Attach/TAU procedure in the current or another satellite of the same PLMN.

Optionally, the list of Satellite IDs (also called as satellite IDs herein) over which the UE may re-attempt the Attach/TAU procedure/service request procedure or any other NAS procedure, optionally after the wait timer expires. In an embodiment, the Satellite IDs can be based on the SIB information broadcasted by the eNB.

The 5G or 4G System with Satellite access may support Store and Forward mechanism (i.e., S/F operating mode or mechanism) when feeder link is not available for the serving satellite at the current UE location.

As mentioned above, the UE receives a wait timer and satellite IDs from MME on-board when MME ground is not available.

If the UE receives a wait timer and satellite IDs in Attach/TAU reject or Attach/TAU Accept message and then a paging indication is sent for that UE, how the paging should be handled is not defined.

In an embodiment, there could also be a power consumption issue when UE is detached from network due to network initiated DEREGISTRATION REQUEST and if there is no satellite ID information available with it.

Currently, there are no solutions for handling a paging on wait timer running case. The UE can stop the timer and attempt on current satellite irrespective of whether it is a stored satellite ID or not.

Currently, there are no solutions for managing the UE power consumption when the UE is detached if there is no satellite ID information available with it.

The satellite coverage availability information (SCAI) also can have this information.

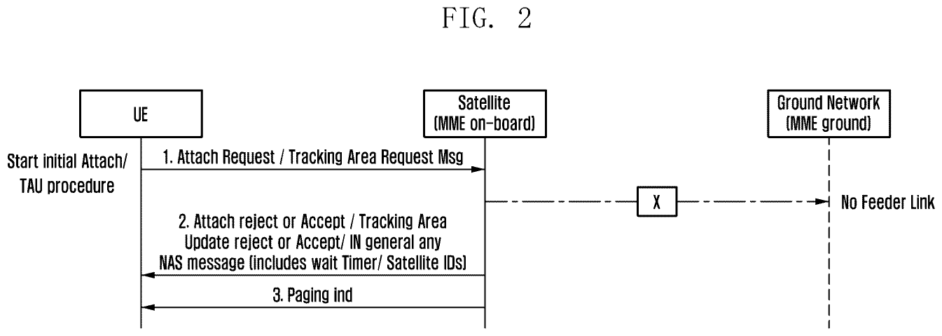

FIG. 2 depicts a scenario, wherein the UE receives a paging indication from network when the wait timer is running according to an embodiment of the disclosure.

In step 1, the UE starts an initial Attach procedure/TAU procedure and sends an Attach request/TAU request to the MME on-board satellite via available service link. In step 2, in the absence of feeder link, the MME on-board cannot forward the UE NAS signalling message to the MME on-ground. The MME on-board sends a downlink (DL) NAS message (for example, ATTACH REJECT/Tracking Area Reject Msg) to the UE. The MME on-board includes the wait timer and optionally, the satellite IDs in the DL NAS message. In step 3, the UE receives a DL NAS signaling message, wait timer and satellite IDs from step 2. At a later time period before the expiry of the wait timer, a paging indication for this UE is sent from MME on-board; i.e., when a UE receives a paging indication from network when the wait timer is running, and the UE action is not defined.

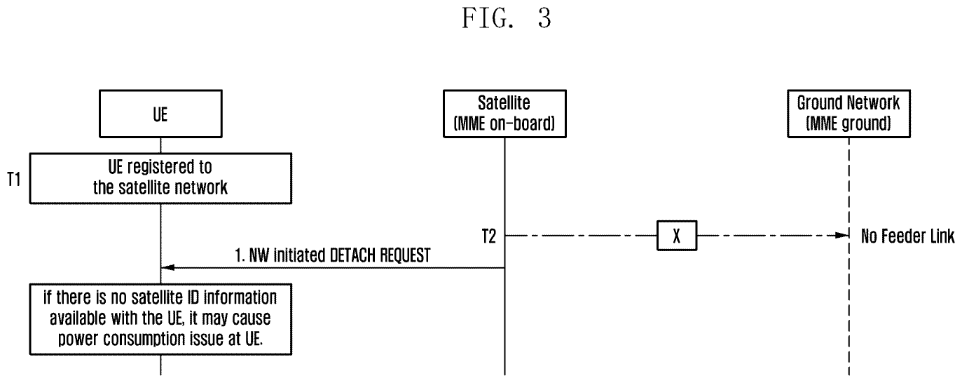

FIG. 3 depicts a scenario, wherein the UE gets detached due to network initiated DETACH REQ according to an embodiment of the disclosure.

In step 1, the UE starts an initial Attach procedure/TAU procedure and sends an Attach request/TAU request to the MME on-board satellite via available service link. In step 2, at time T2, the feeder link become unavailable and MME on-board sends a DL NAS message (for example, DETACH REQUEST MSG) to detach the UE. When the UE gets detached due to a network initiated DETACH REQ, the UE may try registration on any of the available satellites which may not be able to provide normal service to this UE when the UE is switched ON again. This would cause a power consumption issue at the UE side due to unnecessary registration retries via satellites, which cannot provide service.

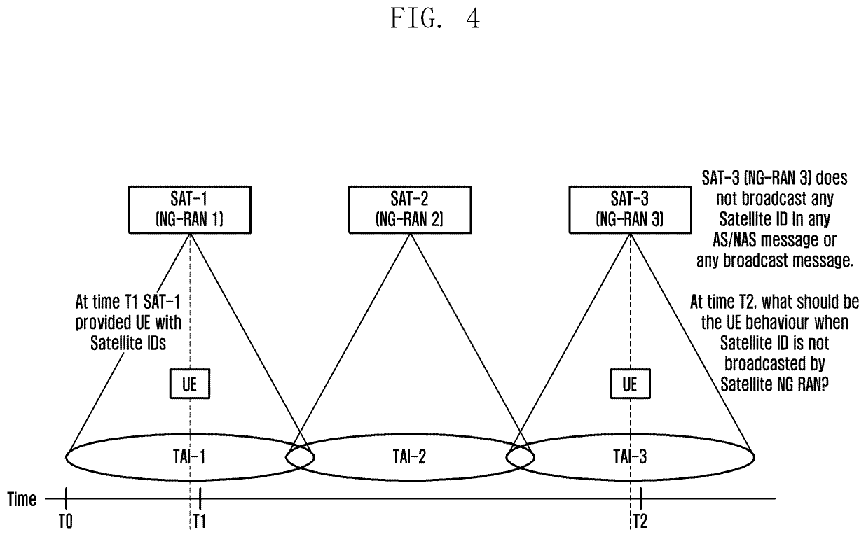

FIG. 4 is a schematic diagram illustrating UE behavior when the satellite RAN is not broadcasting any Satellite ID in the broadcast (for example, MIB/SIB) or any AS or NAS message, according to an embodiment of the disclosure.

At step 1, the UE starts an initial Attach procedure/TAU procedure and sends an Attach request/TAU request to the MME on-board satellite (for example, SAT-1 (NG-RAN-1)) via an available service link. At step 2, the MME on-board sends a DL NAS message (for example, NAS message (for example, Attach Accept/Reject, Tracking Area update Accept/Reject or any other NAS message)) to the UE. The MME on-board includes the satellite ID(s) (for example, SAT-1 & SAT-3) in the DL NAS message. Consider that the UE has moved to a new location or if the time has changed or another satellite coverage (for example, SAT-3) becomes available. When the satellite RAN (for example, SAT-3 (NG-RAN-3)) is not broadcasting any Satellite ID in the broadcast (for example, MIB/SIB) or any AS or NAS message, the UE behavior is not defined.

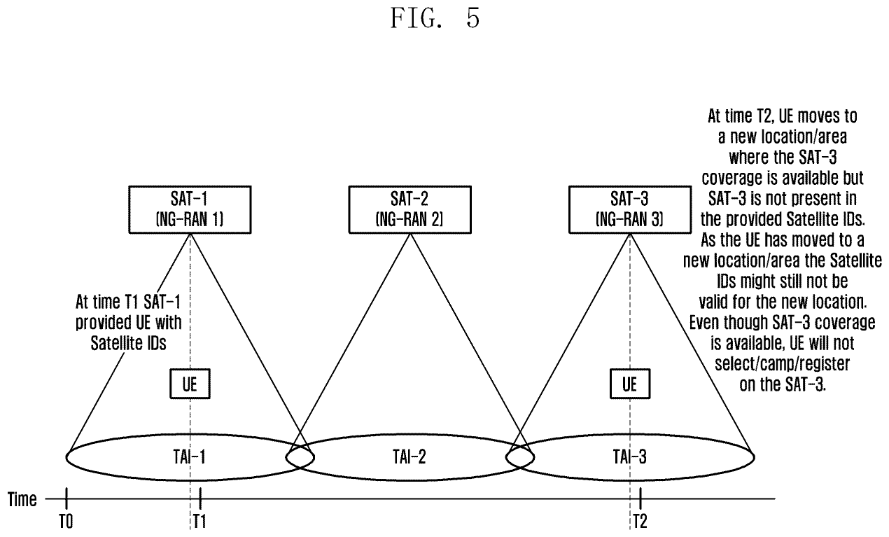

FIG. 5 is a schematic diagram illustrating UE behavior when the location of the UE has changed from the time when it received the Satellite ID(s) from the network according to an embodiment of the disclosure.

At step 1, the UE starts an initial Attach procedure/TAU procedure and sends an Attach request/TAU request to the MME on-board satellite via the available service link. At step 2, in the absence of feeder link, the MME on-board cannot forward UE NAS signalling message to the MME on-ground. The MME on-board sends a DL NAS message (for example, NAS message (for example, Attach Accept/Reject, Tracking Area update Accept/Reject or any other NAS message)) to the UE. The MME on-board includes the wait timer and satellite IDs in the DL NAS message. At step 3, the UE receives DL NAS signalling message with wait timer and satellite IDs (from step 2), and starts the wait timer. The UE starts the Wait Timer and waits till the expiry of the wait timer before reattempting the Attach/TAU procedure on the satellite with these Satellite IDs, optionally on per PLMN basis. When the UE moves away from the location where it received the Satellite ID(s) from the network, it is not clear as to how long should the UE keep these Satellite ID(s) as valid. As the UE location has changed from the time when it received the Satellite ID(s) from the network, it is also not clear as to how the UE determines whether these Satellite ID(s) be still valid for the new UE location.

For resolving the above mentioned drawback(s), the principal object of embodiments herein is to disclose methods and systems for managing satellite parameters in 3GPP networks.

Another object of embodiments herein is to disclose methods and systems for managing satellite parameters in 3GPP networks, on a UE receiving a paging message.

Another object of embodiments herein is to disclose methods and systems for managing satellite parameters in 3GPP networks, on a UE receiving a DETACH REQUEST MSG from the network.

Another object of embodiments herein is to disclose methods and systems for handling validity of satellite ID and TAI list in 3GPP networks.

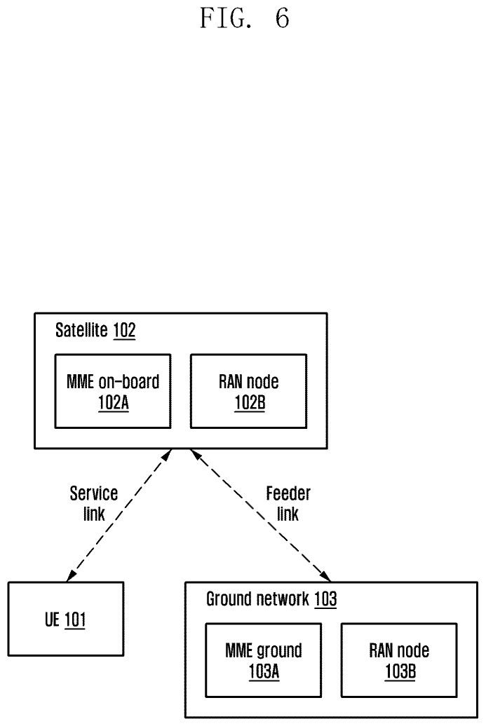

FIG. 6 depicts a 3GPP network, wherein the network 100 comprises one or more User Equipments (UEs) 101, wherein the UEs 101 can be connected to at least one satellite 102, and at least one ground network 103 according to an embodiment of the disclosure.

The at least one satellite 102 can comprise a Mobility Management Entity (MME) on-board 102A, and a RAN node 102B. The at least one ground network 103 can comprise a Mobility Management Entity (MME) ground 103A, and a RAN node 103B.

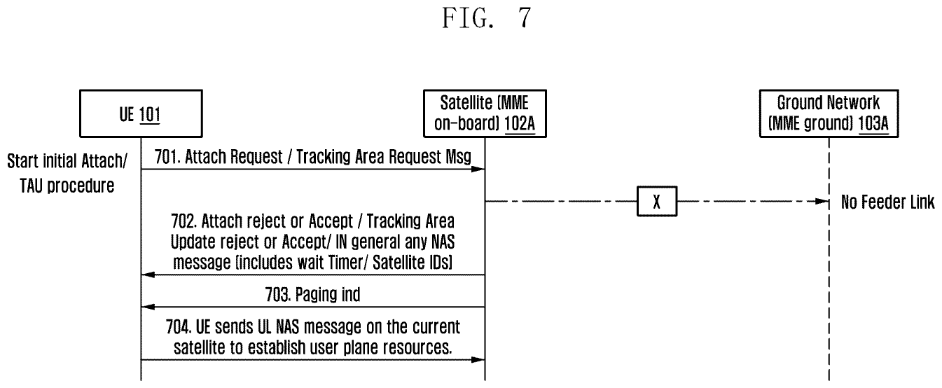

FIG. 7 depicts a scenario, wherein a UE receives a paging indication from the network according to an embodiment of the disclosure.

In step 701, the UE 101 starts an initial Attach procedure/TAU procedure and sends an Attach request/TAU request to the MME on-board 102A via an available service link and gets registered to the satellite network. In the absence of the feeder link, in step 702, the MME on-board 102A cannot forward the UE NAS signaling message to the MME ground 103A. The MME on-board 102A sends a DL NAS message (for example, ATTACH REJECT/Tracking Area Reject/Attach accept/TAU accept message or any other NAS signalling message) to the UE 101. The MME on-board 102A includes the wait timer and satellite IDs in the DL NAS message. In step 703, the UE 101 receives the DL NAS signaling message, the wait timer, and the satellite IDs from the MME on-board 102A, and stores the received DL NAS signaling message, the wait timer, and the satellite IDs in the ME or USIM (as received in step 702). As per the received wait timer, the UE 101 should wait before re-attempting the Attach/TAU procedure in the current or another satellite of the same PLMN. Consider that at a time period before the expiry of the wait timer (i.e., while the wait timer is running), the UE 101 receives a paging indication from the network (i.e., a RAN node 103B) initiated by the MME on-board 102A due to DL data/signalling. On the UE 101 receiving the paging message, in step 704, the UE 101 shall stop/invalidate the wait timer. In another embodiment herein, the UE 101 can optionally delete/invalidate the stored satellite IDs (as received at step 702). The UE 101 responds to the paging message by sending the NAS message (for example, service request (SR), control plane SR, extended SR, and so on) on the current cell optionally, irrespective of the satellite IDs stored in the UE 101. On the UE 101 receiving the paging indication before expiry of the wait timer, the UE 101 will not consider the satellite IDs while sending the NAS message.

In an embodiment, on the UE 101 receiving the paging indication before expiry of the wait timer (i.e., the wait timer is running), the UE 101 waits until the expiry of the wait timer (as provided in step 702). Once the wait timer expires, the UE 101 shall send a UL NAS message (for example, service request) on the current satellite, irrespective of the satellite IDs stored.

In an embodiment the wait timer is also called as S&F Wait Timer or timer T3451.

In another embodiment the terms satellite IDs or list of satellite IDs or at least one satellite ID or S&F Monitoring List are used interchangeably and have same meaning.

When the UE 101 receives the paging indication before expiry of the wait timer (i.e., the wait timer is running), the UE 101 waits until the expiry of the wait timer (as provided in step 702). Once the wait timer expires, the UE 101 shall send the UL NAS message (for example, service request) on the current satellite considering the satellite IDs (as stored in step 702); i.e., if the NG-RAN cell belongs (for example, by broadcasting) to at least one of the satellite IDs stored in the UE (as received in step 702). Otherwise, if the UE 101 is not camped on the cell broadcasting at least one of the stored satellite IDs, then the UE 101 will ignore the paging message.

In an embodiment, if the UE 101 receives the paging indication/message (while the wait timer is running), the UE 101 ignores/discards the paging message and does not respond to the paging message.

In another embodiment herein, the paging message can be received by the UE 101 on the cell which is
broadcasting the satellite ID part of list of satellite IDs stored in the UE 101. In this case, the UE 101 responds to the paging message by triggering the NAS procedure; for example, a service request procedure, an attach procedure, a TAU procedure, and so on.
broadcasting the satellite ID not part of list of satellite IDs which is stored in the UE. In an embodiment herein, the UE 101 responds to the paging message, by triggering the NAS procedure (for example, a service request procedure, an attach procedure, a TAU procedure, and so on). In an embodiment, the UE 101 ignores/discards the paging message, and does not trigger the NAS procedure (for example, a service request procedure, an attach procedure, a TAU procedure, and so on).
broadcasting the satellite ID, wherein the list of satellite IDs are not stored in the UE. In an embodiment herein, the UE 101 responds to the paging message, by triggering the NAS procedure (for example, a service request procedure, an attach procedure, a TAU procedure, and so on). In an embodiment, the UE 101 ignores/discards the paging message, and does not trigger the NAS procedure s (for example, a service request procedure, an attach procedure, a TAU procedure, and so on).
not broadcasting the satellite ID. In another embodiment herein, the UE 101 responds to the paging message by triggering the NAS procedure (for example, a service request procedure, an attach procedure, a TAU procedure, and so on). In an embodiment herein, the UE 101 ignores/discards the paging message, and does not trigger the NAS procedure (for example, a service request procedure, an attach procedure, a TAU procedure, and so on).

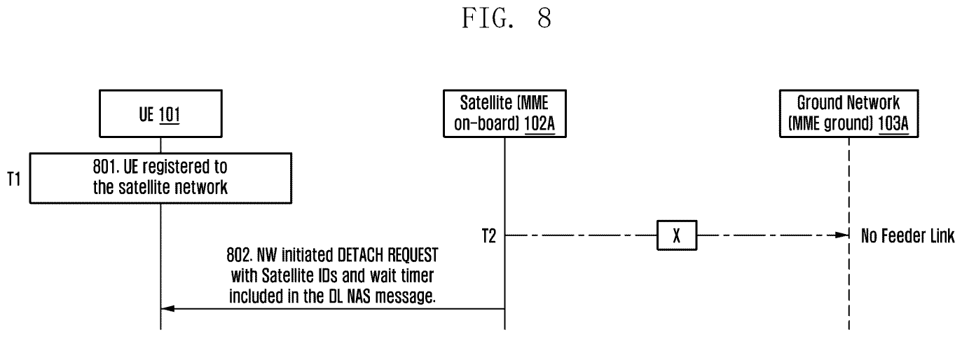

FIG. 8 depicts a scenario, wherein the UE gets detached due to a network initiated DETACH REQUEST message which can be triggered to detach the UE from the PS or PS/CS or CS services, or network initiated deregistration request message according to an embodiment of the disclosure. The detach procedure can be used:
by the UE 101 to detach for EPS services only;
by the UE 101 to disconnect from the last remaining PDN that it is connected to, if the EMM-REGISTERED without PDN connection is not supported by the UE 101 or the MME 102A/103A;
by the UE 101 in CS/PS mode 1, or CS/PS mode 2 of operation to detach for both EPS services and non-EPS services, or for non-EPS services only via a combined detach procedure;
by the network to inform the UE 101 that it is detached for EPS services or non-EPS services or both;
by the network to disconnect the UE 101 from the last remaining PDN to which it is connected if EMM-REGISTERED without PDN connection is not supported by the UE 101 or the MME; and
by the network to inform the UE 101 to re-attach to the network and re-establish all PDN connections.

In step 801, at time T1, the UE 101 starts an initial Attach procedure/TAU procedure and sends an Attach request/TAU request to the MME on-board 102A via an available service link and gets registered to the satellite network. In step 802, at time T2, the feeder link becomes unavailable, and the MME on-board 102A sends a DL NAS message (for example, a DETACH REQUEST MSG) to detach the UE 101. The DETACH REQUEST message from the MME on-board 102A also, for example, includes the wait timer and satellite ID information (also called as list of satellite IDs). Upon receiving the DETACH REQUEST Message from network, the UE 101 stores the received satellite IDs and the wait timer. The UE 101 optionally moves to the EMM-DEREGISTERED STATE. As per the wait timer (if received), the UE 101 should wait before re-attempting the Attach/TAU/service request procedure or any other NAS or AS procedure in the current or another satellite of the PLMN. Upon expiry of the wait timer (if provided), the UE 101 should consider the Satellite ID(s) stored to re-attempt registration and send a UL NAS message (for example, ATTACH REQUEST or a service request) on the cells, or broadcast the satellite ID stored in the UE 101. If the UE 101 is on the cell that is not broadcasting the stored satellite ID (also referred to herein as a list of satellite IDs), the UE 101 will not trigger the NAS procedure.

The UE 101 does not consider the wait timer (as provided in step 802). The UE 101 re-attempts the registration immediately by considering the satellite ID information stored. The UE 101 further sends a UL NAS message (for example, ATTACH REQUEST) on the satellite, considering the satellite ID information.

In an embodiment, considering that the satellite ID information (as stored by the UE 101) implies the UE 101 will take the actions on the RAN (eNB/gNB) cell, which indicates (for example, by broadcasting) the stored satellite ID. If the UE 101 is on the RAN cell (which does not indicate the stored satellite ID), then the UE 101 will not take the actions as described herein.

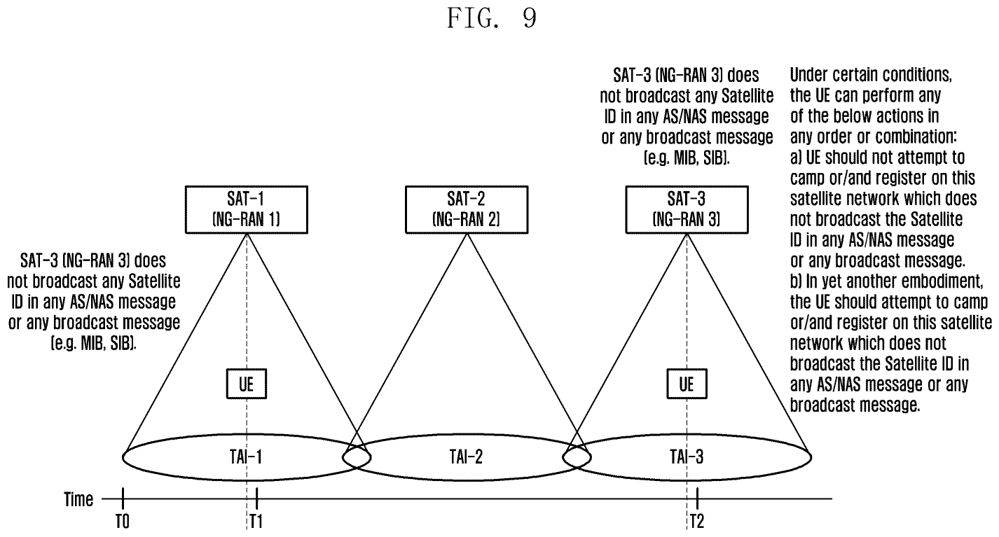

FIG. 9 is a diagram illustrating UE behavior when the satellite RAN is not broadcasting any Satellite ID in the broadcast (for example, MIB/SIB) or any AS or NAS message, and the UE is having satellite ID(s) (also referred to herein as a list of satellite IDs) according to an embodiment of the disclosure.

The UE 101 initiates an initial Attach procedure/TAU procedure. The UE 101 further sends an Attach request/TAU request to the MME on-board 102A (for example, SAT-1 (NG-RAN-1)) via an available service link.

The MME on-board 102A sends a DL NAS message (for example, NAS message (for example, Attach Accept/Reject, Tracking Area update Accept/Reject or any other NAS message)) to the UE 101. The MME on-board 102A includes the satellite ID(s) (for example, SAT-1 & SAT-3) in the DL NAS message.

The UE 101 has moved to a new location or if the time has changed or another satellite coverage (for example, SAT-3) becomes available, and the UE 101 has Satellite ID(s) (for example, SAT-1 & SAT-3) stored. If the satellite RAN 102B (for example, SAT-3 (NG-RAN-3)) is not broadcasting any Satellite ID in the broadcast (for example, MIB/SIB) or any AS or NAS message (i.e., the UE 101 is not able to identify the Satellite ID that the given RAN node belongs to), the UE 101 can perform any of the below actions in any order or combination:
The UE 101 should not attempt to camp/select/reselect or/and register on this cell of the satellite network which does not indicate the Satellite ID in any of the AS/NAS message or does not indicate the Satellite ID to the UE (for example, in the broadcast message (for example, MIB, SIB) or in any NAS or AS message).
The UE 101 should attempt to camp/select/reselect or/and register on this cell of the satellite network which does not broadcast the Satellite ID in any AS/NAS message or any broadcast message (for example, MIB, SIB). Optionally, the UE 101 ignores the stored satellite IDs(s) (i.e., the list of satellite IDs) received from the network.

In an embodiment, when the UE 101 has moved to a new location/area (for example, the UE 101 is first time attaching/registering on a cell for S&F services) or if the time has changed or another satellite coverage (for example, SAT-3) becomes available and the UE 101 does not have Satellite ID(s) stored. For example, the UE 101 has deleted it or ignoring the stored list because the UE 101 is not in the registration area (or TAI list) where it received the list of satellite IDs. If the satellite RAN 102B (for example, SAT-3 (NG-RAN-3)) is broadcasting any Satellite ID in the broadcast (for example, MIB/SIB) or any AS or NAS message (i.e., the UE 101 can identify the Satellite ID the given RAN node belongs to), the UE 101 can perform any of the below actions in any order or combination:
The UE 101 should not attempt to camp/select/reselect or/and register on this cell of the satellite network which does not indicate the Satellite ID in any of the AS/NAS message or does not indicate the Satellite ID to the UE 101 (for example, in the broadcast message (for example, MIB, SIB) or in any NAS or AS message).
The UE 101 should attempt to camp/select/reselect or/and register on this cell of the satellite network which does not broadcast the Satellite ID in any AS/NAS message or any broadcast message (for example, MIB, SIB). Optionally, the UE 101 can ignore the stored satellite IDs(s) (i.e., the list of satellite IDs) received from the network.

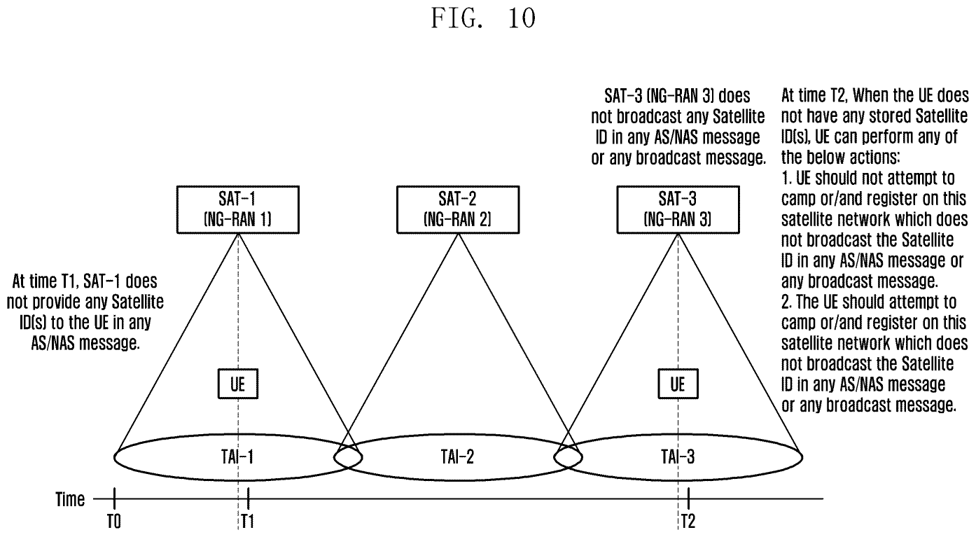

FIG. 10 is a schematic diagram illustrating UE behavior when the satellite RAN is not broadcasting any Satellite ID in the broadcast (for example, MIB/SIB) or any AS or NAS message, and the UE does not have satellite ID(s) according to an embodiment of the disclosure. The UE 101 starts an initial Attach procedure/TAU procedure and sends an Attach request/TAU request to the MME on-board 102A (for example, SAT-1 (NG-RAN-1)) via an available service link.

The MME on-board 102A sends a DL NAS message (for example, a NAS message (for example, Attach Accept/Reject, Tracking Area update Accept/Reject or any other NAS message)) to the UE 101. The MME on-board 102A does not include satellite ID(s) in the DL NAS message.

The UE 101 has moved to a new location/area (for example, the UE 101 is first time attaching/registering on a cell for S&F services) or if the time has changed or another satellite coverage (for example, SAT-3) becomes available, and the UE 101 does not have any Satellite ID(s) stored. In an embodiment, if the satellite RAN 102B (for example, SAT-3 (NG-RAN-3)) is not broadcasting any Satellite ID in the broadcast (for example, MIB/SIB) or any AS or NAS message, the UE 101 can perform any of the below actions in any order or combination:
The UE 101 should not attempt to camp/select/reselect or/and register on this cell of the satellite network which does not indicate the Satellite ID in any of the AS/NAS message or does not indicate the Satellite ID to the UE 101 (for example, in the broadcast message (for example, MIB, SIB) or in any NAS or AS message).
The UE 101 should attempt to camp/select/reselect or/and register on this cell of the satellite network, which does not broadcast the Satellite ID in any AS/NAS message or any broadcast message (for example, MIB, SIB). Optionally, the UE 101 ignores the stored satellite IDs(s) (list of satellite IDs) received from the network.

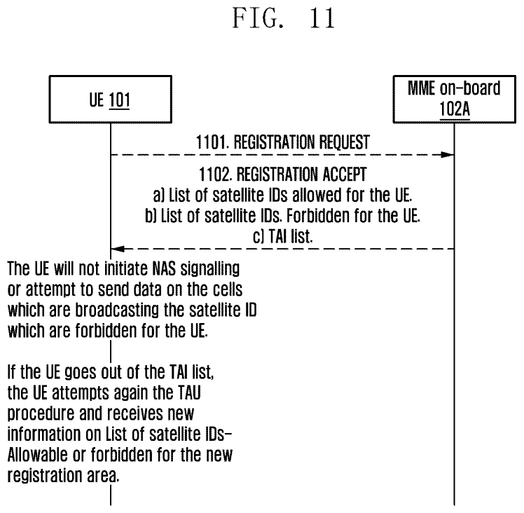

FIG. 11 is a sequence diagram illustrating UE behavior when UE location has changed from the time when it received the Satellite ID(s) from the network according to an embodiment of the disclosure.

In step 1101, the UE 101 starts an initial Attach procedure/TAU procedure, and sends an Attach request/TAU request to the MME on-board 102A via the available service link.

The MME on-board 102A sends a DL NAS message (for example, a NAS message (for example, Attach Accept/Reject, Tracking Area update Accept/Reject or any other NAS message)) to the UE 101. The MME on-board 102A includes the wait timer, list of satellite IDs and the TAI lists (which can be the registration area) in the DL NAS message. The MME on-board 102A generates and provides to the UE 101 at least one of the below information:

a) A list of satellite IDs that are allowed for the UE 101. In this case, any cell which is not broadcasting the satellite ID part of this list is considered forbidden for the UE.

b) A list of satellite IDs that are forbidden for the UE 101. In this case, any cell which is not broadcasting the satellite ID part of this list is considered allowed for the UE 101.

c) A TAI list, which comprises all the TAIs where the list of satellite IDs are broadcasted. This should have cells/TAIs of both forbidden and allowed satellite IDs.

On receiving DL NAS signalling message with the wait timer, satellite IDs and the TAI lists, list of allowed or forbidden satellite IDs (from step 1102), the UE 101 starts the Wait Timer. In an embodiment, the UE 101 waits till the expiry of the wait timer before reattempting the Attach/TAU procedure on the cells that broadcast the allowed Satellite IDs, optionally on per PLMN basis. The UE 101 will not initiate NAS signalling or attempt to send data on the cells that are broadcasting the satellite ID, which are forbidden for the UE 101. The list of satellite IDs (allowed or forbidden) is valid for a given registration area (TAI list). If the UE 101 goes out of the TAI list, the UE 101 attempts the registration procedure or TAU procedure again, and receives new information on the list of satellite IDs (allowable or forbidden for the new area; for example, the registration area). If the UE 101 moves to a new location/area which is not present/part of the TAI list/Registration area (for example, if the UE 101 moves to TAI-3), the UE 101 can perform any of below actions in any order or combination:

a) The UE 101 should ignore/discard or/and delete the stored list of satellite IDs.

b) The UE 101 should select or reselect any cell that is broadcasting or not broadcasting any satellite ID. The UE 101 triggers NAS signalling (for example, the TAU procedure).

In an embodiment herein, outside the TAI list, though the UE 101 has the stored satellite IDs received in the TAI list, the UE 101 can consider all the cells (whether broadcasting satellite ID or not broadcasting the satellite ID) as allowed cells for the UE 101.

In an embodiment, outside the TAI list, though the UE 101 has the stored satellite IDs received in the TAI list, the UE 101 can consider all the cells (whether broadcasting satellite ID or not broadcasting the satellite ID) as forbidden cells for the UE 101.

In another embodiment herein, the TAI list can be on a per PLMN basis; i.e., the UE 101 will use the TAI list-1 (when it is on (camped on) the PLMN-1) and the TAI list-2 (when it is on (camped on) the PLMN-2) and apply the UE 101 behaviour as disclosed herein.

If the UE 101 receives the new TAI list from the network, the UE 101 should delete the old TAI list and replace it with the received TAI list. If the list of satellite IDs is not included on a NAS message (for example, TAU Accept, TAU reject, Service Accept or Service reject or any other response NAS message), the UE 101 shall delete/discard the stored list of satellite IDs.

In an embodiment herein, the TAI list can be any new list, that is not related to the registration area given to the UE 101.

In an embodiment herein, the TAI list is the registration area given to the UE 101.

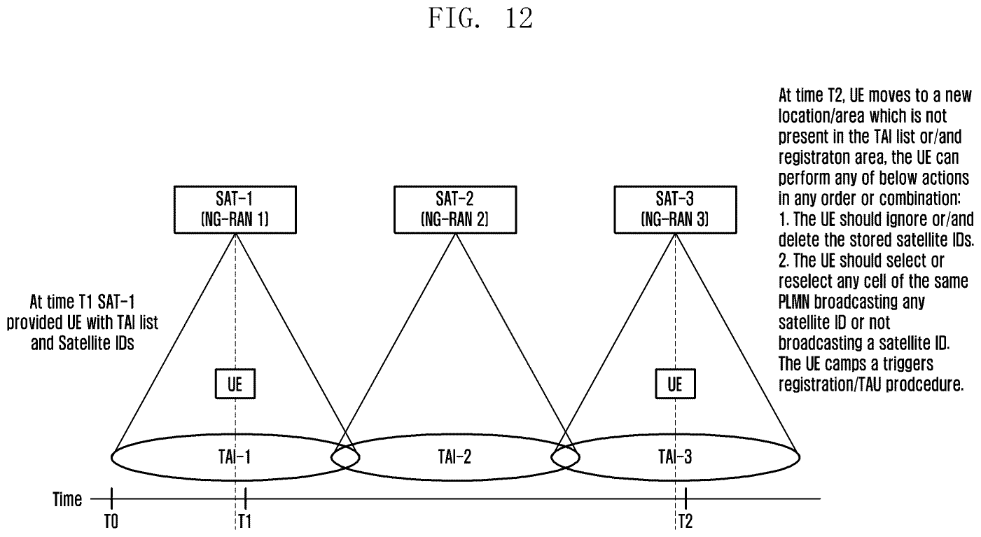

FIG. 12 is a diagram illustrating the behavior of the UE, when the location of the UE has changed from the time when it received the Satellite ID(s) from the network according to an embodiment of the disclosure.

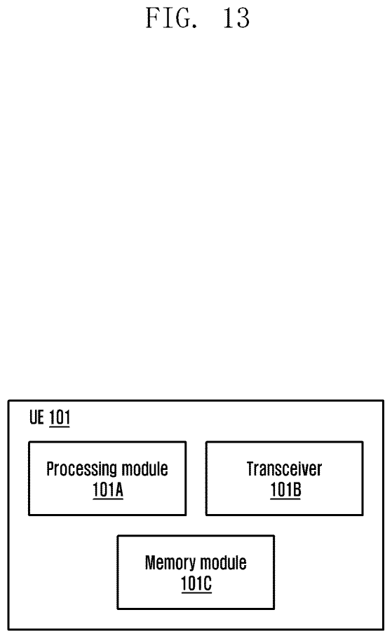

FIG. 13 depicts a UE. The UE 101 comprises a processing module 101A, a transceiver 101B, and a memory module 101C according to an embodiment of the disclosure.

The processing module 101A may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processing module 101A may include multiple cores and is configured to execute the instructions stored in the memory module 101C.

The memory module 101C is configured to store instructions to be executed by the processing module 101A. The memory module 101C can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory module 101C may, in some examples, be considered a non-transitory storage medium. In an embodiment, the term “non-transitory” may indicate that the storage medium is not embodied in a carrier wave or a propagated signal. However, the term “non-transitory” should not be interpreted that the memory module 101C is non-movable. In some examples, the memory module 101C is configured to store larger amounts of information. In certain examples, a non-transitory storage medium may store data that can, over time, change (e.g., in Random Access Memory (RAM) or cache).

The transceiver module 101B includes an electronic circuit specific to a standard that enables wired or wireless communication, via the ˜˜. The transceiver module 101B is configured to communicate internally between internal hardware components of the UE 101, and with external devices via one or more networks.

The processing module 101A can handle S&F satellite operations in the 3GPP network. The processing module 101A can receive a DETACH REQUEST message from the MME on-board 102A, via the transceiver module 101B. In an embodiment herein, the received DETACH REQUEST message includes a list comprising at least one satellite ID, wherein the processing module 101A can store the received list in a suitable location (such as, but not limited to, the memory module 101C). In an embodiment herein, the list comprises satellites belonging to the same PLMN. On receiving the DETACH REQUEST message from the MME on-board 102A, the processing module 101A can enter an EMM-DEREGISTERED state. The processing module 101A can re-attempt an attach request procedure with a satellite from the list.

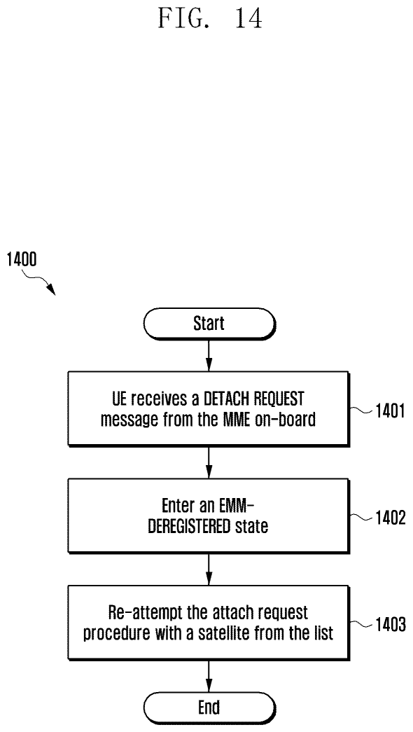

FIG. 14 is a flowchart depicting the process of handling S&F satellite operations in the 3GPP network according to an embodiment of the disclosure.

In operation 1401, the UE 101 receives a DETACH REQUEST message from the MME on-board 102A. In an embodiment herein, the received DETACH REQUEST message includes a list comprising at least one satellite ID, wherein the processing module 101A can store the received list in a suitable location (such as, but not limited to, the memory module 101C). In an embodiment herein, the list comprises satellites belonging to the same PLMN. On receiving the DETACH REQUEST message from the MME on-board 102A, in operation 1402, the UE 101 enters an EMM-DEREGISTERED state. In operation 1403, the UE 101 re-attempts the attach request procedure with a satellite from the list. The various actions in method 1400 may be performed in the order presented, in a different order or simultaneously. Further, in some embodiments, some actions listed in FIG. 14 may be omitted.

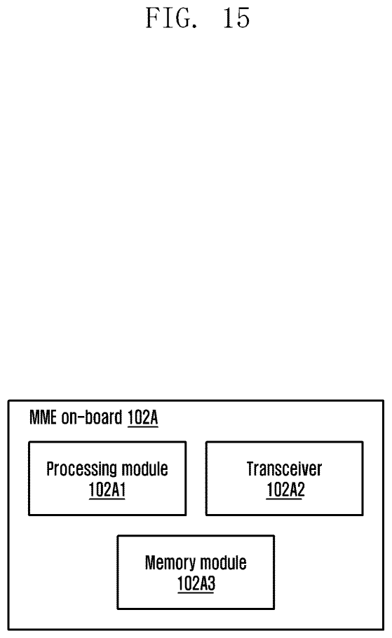

FIG. 15 depicts an MME on-board. The MME on-board 102A comprises a processing module 102A1, a transceiver 102A2, and a memory module 102A3 according to an embodiment of the disclosure.

The processing module 102A1 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processing module 102A1 may include multiple cores and is configured to execute the instructions stored in the memory module 101C.

The memory module 102A3 is configured to store instructions to be executed by the processing module 102A1. In an embodiment, the memory module 102A3 can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory module 102A3 may, in some examples, be considered a non-transitory storage medium. The term “non-transitory” may indicate that the storage medium is not embodied in a carrier wave or a propagated signal. However, the term “non-transitory” should not be interpreted that the memory module 102A3 is non-movable. In some examples, the memory module 102A3 is configured to store larger amounts of information. In certain examples, a non-transitory storage medium may store data that can, over time, change (e.g., in Random Access Memory (RAM) or cache).

In an embodiment, the transceiver module 102A2 includes an electronic circuit specific to a standard that enables wired or wireless communication. The transceiver module 102A2 is configured to communicate internally between internal hardware components of the MME 102A, and with external devices via one or more networks.

The processing module 102A1 can handle S&F satellite operations in the 3GPP network. The processing module 102A1 can initiate a detach procedure for a UE 101. The processing module 102A1 can send a DETACH REQUEST message to the UE 101. In an embodiment, the DETACH REQUEST procedure includes a list comprising at least one satellite ID, wherein the UE 101 attempts to connect to a satellite from the list, on re-attempting the attach procedure. In an embodiment herein, the list comprises satellites belonging to the same Public Land Mobile Network (PLMN).

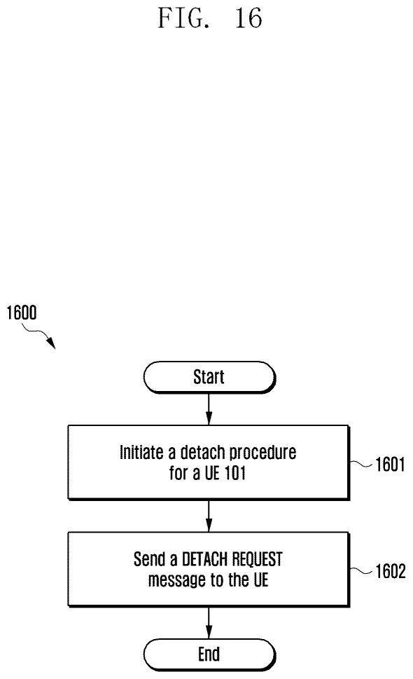

FIG. 16 is a flowchart depicting a process of handling S&F satellite operations in the 3GPP network according to an embodiment of the disclosure.

In operation 1601, the MME 102A initiates a detach procedure for a UE 101. On initiating the detach procedure, in operation 1602, the MME 102A sends a DETACH REQUEST message to the UE 101. The DETACH REQUEST procedure includes a list comprising at least one satellite ID, wherein the UE 101 attempts to connect to a satellite from the list, on re-attempting the attach procedure. In an embodiment herein, the list comprises satellites belonging to the same Public Land Mobile Network (PLMN). The various actions in method 1600 may be performed in the order presented, in a different order or simultaneously. Further, in some embodiments, some actions listed in FIG. 16 may be omitted.

The embodiments disclosed can be implemented through at least one software program running on at least one hardware device and performing network management functions to control the network elements. The elements include blocks which can be at least one of a hardware device, or a combination of hardware device and software module.

The embodiments disclosed describe methods and systems for managing satellite parameters in 3GPP networks. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in example, Very high speed integrated circuit Hardware Description Language (VHDL) another programming language, or implemented by one or more VHDL or several software modules being executed on at least one hardware device. The hardware device can be any kind of portable device that can be programmed. The device may also include means which could be example, hardware means like example, an application-specific integrated circuit (ASIC), or a combination of hardware and software means, example, an ASIC and a field programmable gate array (FPGA), or at least one microprocessor and at least one memory with software modules located therein. The method embodiments described herein could be implemented partly in hardware and partly in software. Alternatively, the disclosure may be implemented on different hardware devices, example, using a plurality of CPUs.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a communication system, the method comprising:
receiving, from a mobility management entity (MME) of a non-terrestrial network (NTN) node, a detach request message for initiating a detach procedure, in an evolved-universal mobile telecommunication access (E-UTRA) mobility management (EMM)-REGISTERED state; and
entering an EMM-DEREGISTERED state after the detach procedure,
wherein the detach request message includes information on a store and forward (S&F) satellite operation, the information on the S&F satellite operation including an S&F monitoring list of a satellite identity (ID).

2. The method of claim 1, further comprising:
storing the S&F monitoring list,
wherein the satellite ID in the S&F monitoring list indicates a satellite where the terminal re-attempt a non-access stratum (NAS) procedure, and
wherein the NTN node and the satellite belong to a same public land mobile network (PLMN).

3. The method of claim 2, further comprising:
identifying the satellite for an access based on the satellite ID; and
transmitting, an MME of the satellite, an uplink NAS message.

4. The method of claim 1, further comprising:
transmitting, to the MME of the NTN node, information indicating a support of the S&F satellite operation,
wherein the information indicating the support of the S&F satellite operation is transmitted during an attach request procedure for entering the EMM-REGISTERED state.

5. A method performed by a non-terrestrial network (NTN) node in a communication system, the method comprising:
determining to initiate a detach procedure for a terminal in an evolved-universal mobile telecommunication access (E-UTRA) mobility management (EMM)-REGISTERED state, based on a current location of the terminal; and
transmitting, by a mobility management entity (MME) of the NTN node to the terminal, a detach request message including information on a store and forward (S&F) satellite operation, the information on the S&F satellite operation including an S&F monitoring list of a satellite identity (ID),
wherein the EMM-REGISTERED state is changed to an EMM-DEREGISTERED state after the detach procedure.

6. The method of claim 5,
wherein the satellite ID in the S&F monitoring list indicates a satellite where the terminal re-attempt a non-access stratum (NAS) procedure, and
wherein the NTN node and the satellite belong to a same public land mobile network (PLMN).

7. The method of claim 6, wherein an uplink NAS message is transmitted from the terminal to an MME of the satellite based on the satellite ID.

8. The method of claim 5, further comprising:
receiving, by the MME of the NTN node from the terminal, information indicating a support of the S&F satellite operation,
wherein the information indicating the support of the S&F satellite operation is received during an attach request procedure of the terminal for entering the EMM-REGISTERED state.

9. A terminal in a communication system, the terminal comprising:
a transceiver; and
a controller configured to:
control the transceiver to receive, from a mobility management entity (MME) of a non-terrestrial network (NTN) node, a detach request message for initiating a detach procedure, in an evolved-universal mobile telecommunication access (E-UTRA) mobility management (EMM)-REGISTERED state, and
enter an EMM-DEREGISTERED state after the detach procedure,
wherein the detach request message includes information on a store and forward (S&F) satellite operation, the information on the S&F satellite operation including an S&F monitoring list of a satellite identity (ID).

10. The terminal of claim 9,
wherein the controller is further configured to store the S&F monitoring list,
wherein the satellite ID in the S&F monitoring list indicates a satellite where the terminal re-attempt a non-access stratum (NAS) procedure, and
wherein the NTN node and the satellite belong to a same public land mobile network (PLMN).

11. The terminal of claim 10, wherein the controller is further configured to:
identify the satellite for an access based on the satellite ID; and
control the transceiver to transmit, an MME of the satellite, an uplink NAS message.

12. The terminal of claim 9,
wherein the controller is further configured to control the transceiver to transmit, to the MME of the NTN node, information indicating a support of the S&F satellite operation, and
wherein the information indicating the support of the S&F satellite operation is transmitted during an attach request procedure for entering the EMM-REGISTERED state.

13. A non-terrestrial network (NTN) node in a communication system, the NTN node comprising:
a base station; and
a mobility management entity (MME) which comprises a transceiver and a controller,
wherein the controller is configured to:
determine to initiate a detach procedure for a terminal in an evolved-universal mobile telecommunication access (E-UTRA) mobility management (EMM)-REGISTERED state, based on a current location of the terminal; and
control the transceiver to transmit, to the terminal, a detach request message including information on a store and forward (S&F) satellite operation, the information on the S&F satellite operation including an S&F monitoring list of a satellite identity (ID), and
wherein the EMM-REGISTERED state is changed to an EMM-DEREGISTERED state after the detach procedure.

14. The NTN node of claim 13,
wherein the satellite ID in the S&F monitoring list indicates a satellite where the terminal re-attempt a non-access stratum (NAS) procedure, and
wherein the NTN node and the satellite belong to a same public land mobile network (PLMN).

15. The NTN node of claim 14, wherein an uplink NAS message is transmitted from the terminal to an MME of the satellite based on the satellite ID.

16. The NTN node of claim 13,
wherein the controller is further configured to control the transceiver to receive, by the MME of the NTN node from the terminal, information indicating a support of the S&F satellite operation, and
wherein the information indicating the support of the S&F satellite operation is received during an attach request procedure of the terminal for entering the EMM-REGISTERED state.
